(19) United States
(12) Patent Application Publication
(10) Pub. No.: US 2003/0109190 A1
(43) Pub. Date: Jun. 12, 2003

(54) Wet-laid nonwoven reinforcing mat

(76) Inventor: Paul A. Geel, Doorwerth (NL)

Correspondence Address: OWENS CORNING, 2790 COLUMBUS ROAD, GRANVILLE, OH, 43023, US

(21) Appl. No.: 10/020,768

(22) Filed: Dec. 12, 2001

(51) Int. Cl. B32B 3/00; D04H 3/00

(52) U.S. Cl. 442/342; 442/331; 442/333; 442/334; 442/375; 442/415

(57) ABSTRACT

A wet-laid nonwoven reinforcing mat includes a base web having about 10 to about 80 percent by weight glass fibers, about 20 to about 90 percent by weight polyethylene terephthalate fibers and polyvinyl alcohol in an amount of about 5 to about 35 percent of the combined weight of the glass fibers and the polyethylene terephthalate fibers. The reinforcing mat also includes a secondary binder in an amount of about 10 to about 30 percent of the total weight of the base web.

### TECHNICAL FIELD AND INDUSTRIAL APPLICABILITY OF THE INVENTION

The present invention relates to a wet-laid nonwoven reinforcing mat of a type that may be used, for example, as a reinforcement for vinyl floor coverings.

### BACKGROUND OF THE INVENTION

Vinyl floor coverings containing a reinforcing layer of glass fiber mat are widely used in residential and commercial construction, in both North America and Europe. Unlike organic felt or paper carriers, the glass mat provides a dimensionally-stable substrate for coating and printing operations during production of the floor covering. Placement of the reinforcement layer near the center of the structure yields a product that resists curling, making the floor covering suitable for loose-lay installations.

Problems exist when the floor covering is installed over a wood subfloor due to the fairly large dimensional changes associated with wood as the environmental temperature and humidity change. As the subfloor “dries out” in the winter, it can shrink by as much as 0.5 percent. Unless the vinyl floor covering can accommodate this change in dimension through compression, the vinyl floor covering may buckle to relieve the compressive loading.

The glass mats currently used as the reinforcing layer in vinyl floor covering have high compressive strengths which can result in buckling when they are installed over wood subfloors. A typical reinforcing mat used in floor coverings consists of glass textile fibers with a diameter of 9 to 11 microns and length of 6 mm. These fibers are typically held together with a rigid binder such as a urea-formaldehyde resin or poly (vinyl alcohol). The high compressive stiffness of these reinforcing mats is not substantially altered during the manufacturing of the floor covering.

U.S. Pat. No. 4,849,281 discloses one solution to the problem of the high compressive stiffness of the glass reinforcing layer. The glass mat of that patent consists of a blend of glass textile fibers and glass wool fibers. These fibers are bonded with an elastomeric binder consisting of a mixture of a carboxylated styrene-butadiene latex and a methylated melamine-formaldehyde resin.

U.S. Pat. No. 6,267,843 discloses another solution. In this patent a base mat is formed from a mixture of glass fibers and polymeric binder fibers and/or powder. This is followed by treatment with a second water 10 based polymeric binder composition. The mat exhibits satisfactory characteristics when used as a substrate for compressible vinyl floor covering.

### SUMMARY OF THE INVENTION

In accordance with the purposes of the present invention as described herein, an improved wet-laid nonwoven reinforcing mat is provided. That mat comprises a base web including about 10 to about 80 percent by weight glass fibers, about 20 to about 90 percent by weight polyethylene terephthalate fibers and polyvinyl alcohol in an amount of about 5 to about 35 percent of the combined weight of the glass fibers and the polyethylene terephthalate fibers. The mat also includes a secondary binder in an amount of about 10 to about 30 percent of the combined weight of the glass fibers, polyethylene terephthalate fibers and polyvinyl alcohol.

More specifically describing the invention the glass fibers may be selected from a group preferably consisting of E glass fibers, C glass fibers, A glass fibers and any mixtures thereof. The glass fibers may also have a diameter of from about 6 to about 16 microns and a length of from about 4 to about 25 mm.

The polyethylene terephthalate fibers may have a diameter of from about 6 to about 16 microns and a length of from about 4 to about 25 mm.

The polyethylene terephthalate fibers have a melting point above about 250° C. and may, for example, also be aramid fibers. The polyethylene terephthalate fibers maintain their fiber character to at least 220° C.

The polyvinyl alcohol utilized in the base web may be in the form of fibers, powder or a mixture of the two. Where the polyvinyl alcohol is in a fiber form, the fibers have a diameter of about 6 to about 20 microns and a length of about 4 to about 12 mm. Where the polyvinyl alcohol is in a powdered form, the powder has a particle size of from about 50 to about 250 microns.

The secondary binder utilized in the reinforcing mat may be substantially any liquid binder known in the art such as a water based emulsion or solution type binder including but not limited to polyvinyl alcohol, acrylic, ethylene vinyl acetate and any mixtures thereof.

The present invention may be more specifically described as relating to a wet-laid nonwoven reinforcing mat having a base web including glass fibers in an amount of about 25 to about 40 percent by weight, polyethylene terephthalate fibers in an amount of about 60 to about 75 percent by weight and polyvinyl alcohol in an amount of about 10 to about 20 percent of the total weight of the glass fibers and the polyethylene terephthalate fibers. The reinforcing mat also includes a secondary binder that is provided in an amount of about 15 to about 25 percent of the total weight of the base web.

In the following description there is shown and described a preferred embodiment of this invention simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### DETAILED DESCRIPTION OF THE INVENTION

The present invention relates to a novel wet-laid nonwoven reinforcing mat which may be utilized, for example, as a reinforcing layer in surface coverings including, particularly, vinyl floor coverings. The wet-laid mat is characterized by a number of unique attributes including improved flexibility. Specifically, the mat of the present invention provides an elongation at break that is a 100 percent improvement versus a traditional glass fiber mat/carrier. The addition of the polyethylene terephthalate fiber in the mat improves the tear strength significantly and reduces worker irritation often associated with traditional glass fiber mat/carrier. When compared to a felt mat/carrier, the reinforcing mat of the present invention provides improved tear strength, improved resistance against moisture and rot, improved appearance and also improved stain resistance.

The reinforcing mat of the present invention comprises a base web including a blend of about 10 to about 80 percent by weight glass fibers and about 20 to about 90 percent by weight polyethylene terephthalate fibers. The web also includes a polyvinyl alcohol binder in an amount of about 5 to about 35 percent of the combined weight of the glass fibers and the polyethylene terephthalate fibers. More typically, the reinforcing mat includes a base web including about 25 to about 40 percent by weight glass fibers, 60 to about 75 percent by weight polyethylene terephthalate fibers and polyvinyl alcohol binder in an amount of about 10 to about 20 percent of the combined weight of the glass fibers and the polyethylene terephthalate fibers.

In addition the reinforcing mat includes a secondary binder in an amount of about 10 to about 30 percent of the total weight of the base web fibers and binder, and more typically in an amount of about 15 to about 25 percent of the total weight of the base web.

The glass fibers utilized in the reinforcing mat are selected from a group consisting of E glass fibers, C glass fibers, A glass fibers and any mixtures thereof. The glass fibers have a diameter ranging from about 6 to about 16 microns and a length ranging from about 4 to about 25 mm.

The polyethylene terephthalate fibers utilized have a melting point above about 250° C. and maintain their fiber character to at least a temperature of 220° C. The polyethylene terephthalate fibers have a fiber diameter ranging from about 6 to about 16 microns and a length ranging from about 4 to about 25 mm. Aramid or any other synthetic fiber meeting these requirements may be utilized.

The polyvinyl alcohol binder may be utilized in the form of fibers or powder or both. The fibers typically have a diameter of about 6 to about 20 microns and a length of about 4 to about 12 mm. The powder has a particle size of about 50 to about 250 microns. The polyvinyl alcohol provides a bonding effect at a temperature range of greater than about 60° C. and less than about 200° C.

Substantially any liquid binder known in the art including, particularly water based emulsion or solution type binders may be utilized as the secondary binder. Depending upon the composition of the base mat and the degree of high temperature strength needed for processing by the flooring manufacturer, the secondary binder may be non-crosslinking, self-crosslinking or may be crosslinked by addition of a suitable agent such as melamine-formaldehyde resin. Appropriate binders include but are not limited to polyvinyl alcohol, acrylic, ethylene vinyl acetate and mixtures thereof. Preferably, the secondary binder provides a bonding effect at a temperature of from about 80 to about 200° C.

The general procedure for preparing the reinforcing mat of the present invention is as follows. A slurry of a blend of glass fibers and polyethylene terephthalate fibers, and fibers or powder of the polyvinyl alcohol binder are formed into a mat using conventional wet-laid forming techniques which are well known to those practiced in the art. The resulting nonwoven web is passed through an oven to dry the mat and fuse the polyvinyl alcohol binder fibers and/or powder. Typically, the oven is maintained at a temperature of 100 to 200° C. and the web has a residence time in the oven of about 15 to 45 seconds. This heating activates the polyvinyl alcohol binder causing that material to melt and bind the glass fibers and polyethylene terephthalate fibers together. Thus, the fiber character of both the glass and polyethylene terephthalate fibers is maintained.

Next the secondary binder is applied by saturating the mat with a water-based polymer solution or dispersion, removing the excess secondary binder and again passing the mat through an oven to dry and cure the secondary binder. Again, the oven may be maintained at a temperature of, for example, 100 to 200° C. and the mat will have a residence time in the oven of approximately 15 to 45 seconds. This heating activates the secondary binder while again maintaining the fiber character of the glass and polyethylene terephthalate fibers. When the resulting mat is substituted for conventional glass mats and typical vinyl floor covering constructions, a marked improvement in compressive behavior is found. Floor coverings containing the new mat are thus highly suitable for use over wooden subfloors.

In an alternative process, a slurry of glass fibers, polyethylene terephthalate fibers and polyvinyl alcohol binder is dewatered to form a wet-laid mat. The secondary water-based binder is then applied to wet-laid mat. This mat is then dewatered a second time and then the mat is dried in an oven to fuse the binders to the glass and polyethylene terephthalate fibers.

In still another approach, a slurry of glass fibers, polyethylene terephthalate fibers and polyvinyl alcohol fibers or powder binder is dewatered to form a wet-laid mat. The mat is then dried in an oven to fuse the polyvinyl alcohol binder to the glass and polyethylene terephthalate fibers. The mat is then rolled up without applying the secondary binder. The secondary binder is then subsequently applied in a separate off-line process at a remote location.

In the various processes, machines such as wire cylinders, Fourdrinier machines, Stevens Former, Roto Former, Inver Former and Venti Former machines are utilized to form the wet-laid mat. A head box deposits the slurry onto a moving wire screen. Suction or vacuum removes the water which results in the wet-laid mat. Conventional ovens perform the drying and fusing steps.

The following examples are presented to further illustrate the present invention. The wet-laid nonwoven reinforcing mat that is the subject of the present invention and is prepared in these examples is suitable for use with vinyl floor coverings and may be substituted for traditional felt or glass fiber mat/carrier materials. The reinforcing mat has enough flexibility to resist the movement of wooden subfloors and supports all types of installation methods including perimeter bonding. The reinforcing mat has a large flexibility of its own (i.e. greater than 4 percent elongation at break) and also supports shrinkage since the polyethylene terephthalate fiber is pre stretched.

### EXAMPLE 1

A base veil is made of 25 percent glass fibers (Owens Corning Advantex 11 micron 6 mm), 75 percent polyethylene terephthalate fibers (Kuraray 0.43 denier 5 mm) and 15 percent polyvinyl alcohol binder on top of the blended fibers to make a base structure. This is done using a conventional inclined wire wet-laid forming process. The wet-laid fiber and binder mix is transported to a belt dryer where the complex is consolidated. The thus formed base structure is additionally impregnated with 20 percent styrene acrylate secondary binder on top of the base structure using a size press and then consolidated in an airflow dryer. The end product is wound on a roll which is slit to the desired width.

### EXAMPLE 2

A base veil is made of 40 percent glass fibers (Owens Corning Advantex 11 microns 6 mm), 60 percent polyethylene terephthalate fibers (Kuraray 0.43 denier 5 mm), and 15 percent polyvinyl alcohol binder on top of the blended fibers to make a base structure. This is done using a conventional inclined wire wet laid forming process. The wet-laid fiber and binder mix is transported to a belt dryer where the complex is consolidated. The thus formed base structure is additionally impregnated with 20 percent styrene acrylate secondary binder on top of the base structure using a size press and then consolidated in an airflow dryer. The end product is wound on a roll and slit to the desired width.

The foregoing description of a preferred embodiment of the invention has been presented for purposes of illustration and description. It is not intended to be exhaustive or to limit the invention to the precise form disclosed. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A wet-laid nonwoven reinforcing mat, comprising:
(a.) a base web including about 10 to about 80 percent by weight glass fibers, and about 20 to about 90 percent by weight polyethylene terephthalate fibers;
(b) polyvinyl alcohol in an amount of about 5 to about 35 percent of the combined weight of the glass fibers and the polyethylene terephthalate fibers; and
(c.) a secondary binder in an amount of about 10 to about 30 percent of the combined weight of said glass fibers, polyethylene terephthalate fibers and polyvinyl alcohol.

2. The reinforcing mat of claim 1 wherein said glass fibers are selected from a group consisting of E glass fibers, C glass fibers, A glass fibers and any mixtures thereof.

3. The reinforcing mat of claim 1 wherein said glass fibers have a diameter of from about 6 to about 16 microns and a length of from about 4 to about 25 mm.

4. The reinforcing mat of claim 1 wherein said polyethylene terephthalate fibers have a diameter of from about 6 to about 16 microns and a length of from about 4 to about 25 mm.

5. The reinforcing mat of claim 1 wherein said polyethylene terephthalate fibers have a melting point above about 250° C.

6. The reinforcing mat of claim 5 wherein said polyethylene terephthalate fibers are aramid fibers.

7. The reinforcing mat of claim 1 wherein said polyethylene terephthalate fibers maintain their fiber character to at least 220° C.

8. The reinforcing mat of claim 1 wherein said polyvinyl alcohol is in a form of a fiber, a powder or both.

9. The reinforcing mat of claim 1 wherein said polyvinyl alcohol is in a fiber form having a diameter of about 6 to about 20 microns and a length of about 4 to about 12 mm.

10. The reinforcing mat of claim 1 wherein said polyvinyl alcohol is in a powder form having a particle size of from about 50 to about 250 microns.

11. The reinforcing mat of claim 1 wherein said secondary binder is a water based emulsion or solution type binder.

12. The reinforcing mat of claim 1 wherein said secondary binder is selected from a group consisting of polyvinyl alcohol, acrylic, ethylene vinyl acetate and any mixtures thereof.

13. The reinforcing mat of claim 1 wherein said base web includes glass fibers in an amount of about 25 to about 40 percent by weight of the fibers.

14. The reinforcing mat of claim 1 wherein said base web includes polyethylene terephthalate fibers in an amount of about 60 to about 75 percent by weight of the fibers.

15. The reinforcing mat of claim 1 wherein said polyvinyl alcohol is provided in an amount of about 10 to about 20 percent of the total weight of the glass fibers and the polyethylene terephthalate fibers.

16. The reinforcing mat of claim 1 wherein said secondary binder is provided in an amount of about 15 to about 25 percent of the total weight of said base web.

17. The reinforcing mat of claim 1 wherein said base web includes glass fibers in an amount of about 25 to about 40 percent by weight, polyethylene terephthalate fibers in an amount of about 60 to about 75 percent by weight and polyvinyl alcohol in an amount of about 10 to about 20 percent of the total weight of the glass fibers and the polyethylene terephthalate fibers.

18. The reinforcing mat of claim 17, wherein said secondary binder is provided in an amount of about 15 to about 25 percent of the total weight of said base web.

19. The reinforcing mat of claim 18 wherein said polyvinyl alcohol is in a fiber form having a diameter of about 6 to about 20 microns and a length of about 4 to about 12 mm.

20. The reinforcing mat of claim 19 wherein said polyvinyl alcohol is in a powder form having a particle size of from about 50 to about 250 microns.
